(19) United States
(12) Patent Application Publication
(10) Pub. No.: US 2023/0305456 A1
(43) Pub. Date: Sep. 28, 2023

(54) HEAT FIXING DEVICE, SLIDING DEVICE, AND SLIDABLE MEMBER

(71) Applicant: CANON KABUSHIKI KAISHA, Tokyo (JP)

(72) Inventor: YOSHIHITO OSHIMA, Kanagawa (JP)

(21) Appl. No.: 18/186,046

(22) Filed: Mar. 17, 2023

(30) Foreign Application Priority Data
Mar. 22, 2022 (JP) 2022-045820
Mar. 6, 2023 (JP) 2023-033821

(51) Int. Cl. G03G 15/20

(52) U.S. Cl. CPC G03G 15/2025

(57) ABSTRACT

A heat fixing device including: a first member configured to be rotatable; a heater capable of heating the first member; a second member configured to be rotatable, which forms a nip portion with the first member, and a biasing member, which is arranged inside the first member, has a sliding surface against an inner peripheral surface of the first member, and is configured to bias the first member toward the second member, the heat fixing device having an oil film containing perfluoropolyether between the inner peripheral surface of the first member and the sliding surface of the biasing member, and when adhering a 1-microliter droplet of a perfluoropolyether having a kinematic viscosity of 500 mm2/s at an arbitrary position on the sliding surface at a temperature of 23° C., a contact angle of the droplet being 50° to 65°, and a sliding angle of the droplet being 30° to 40°.

### BACKGROUND

### Technical Field

The present disclosure relates to a heat fixing device, a sliding device, and a slidable member.

### Description of the Related Art

Various mechanical apparatus, such as industrial equipment and an electrophotographic image forming apparatus, sometimes include a sliding portion in which two members are brought into contact in a relatively slidable manner.

In Japanese Patent Application Laid-Open No. 2004-191744, there is a disclosure relating to a fixing device to be used for an electrophotographic image forming apparatus, and to a tubular body for fixation to be used for the fixing device. The fixing device includes: a fixing member placed in a rotatable manner; a tubular body for fixation arranged in pressure contact with the fixing member in a manner rotatable following the fixing member; and a pressing member arranged inside the tubular body for fixation and configured to press the tubular body for fixation toward the fixing member side. The fixing device further includes: a sheet-shaped member interposed between the tubular body for fixation and the pressing member; a lubricant interposed between the tubular body for fixation and the sheet-shaped member; and a heating source for heating the nip portion. In addition, the tubular body for fixation has a liquid-repellent finished portion, which repels the lubricant, in at least part of an inner peripheral surface end portion thereof. In Japanese Patent Application Laid-Open No. 2004-191744, there is a description that the tubular body for fixation can prevent depletion of the lubricant between the tubular body for fixation and the sheet-shaped member due to leakage of the lubricant from both ends of the tubular body for fixation.

According to an investigation made by the inventor, the tubular body for fixation according to Japanese Patent Application Laid-Open No. 2004-191744 was effective for the prevention of the depletion of the lubricant. However, the lubricant is repelled at the liquid-repellent finished portion, and hence sliding resistance with the sheet-shaped member was increased at the liquid-repellent finished portion in some cases. Faced with a demand for a further improvement in environmental performance of the electrophotographic image forming apparatus, the inventor has recognized a need to develop a novel technology capable of achieving a further reduction in sliding resistance while holding the lubricant in the sliding portion over a long period of time.

### SUMMARY

At least one aspect of the present disclosure is directed to providing a heat fixing device having a sliding portion including two members configured to be relatively slidable via an oil film containing a perfluoropolyether, in which the oil film can be stably present in the sliding portion, and in which sliding resistance at the sliding portion is further reduced.

In addition, at least one aspect of the present disclosure is directed to providing a sliding device having a sliding portion including two members configured to be relatively slidable via an oil film containing a perfluoropolyether, in which the oil film can be stably present in the sliding portion, and in which sliding resistance at the sliding portion is further reduced.

Further, at least one aspect of the present disclosure is directed to providing a slidable member conducive to the formation of a sliding portion capable of stably exhibiting low friction over a long period of time.

According to at least one aspect of the present disclosure, there is provided a heat fixing device including: a first member configured to be rotatable; a heater capable of heating the first member; a second member configured to be rotatable, which forms a nip portion with the first member, at the nip portion a recording material being held with the first member; and a biasing member, which is arranged inside the first member, has a sliding surface against an inner peripheral surface of the first member, and is configured to bias the first member toward the second member, the heat fixing device having an oil film containing a perfluoropolyether, the oil film being present between the inner peripheral surface of the first member and the sliding surface of the biasing member, and when adhering a 1-microliter droplet of a perfluoropolyether having a kinematic viscosity of 500 mm²/s at an arbitrary position on the sliding surface at a temperature of 23° C., a contact angle of the droplet being 50° to 65°, and a sliding angle of the droplet being 30° to 40°.

In addition, according to at least one aspect of the present disclosure, there is provided a sliding device including a first member and a second member, which are brought into contact with each other in a relatively slidable manner with an oil film in-between, the oil film containing a perfluoropolyether, the first member having a first surface opposed to the second member, the second member having a second surface opposed to the first member, and at least one surface selected from the group consisting of: the first surface and the second surface, satisfies the following conditions.

### <Conditions>

When adhering a 1-microliter droplet of a perfluoropolyether having a kinematic viscosity of 500 mm²/s at an arbitrary position on the at least one surface at a temperature of 23° C., a contact angle of the droplet is 50° to 65°, and a sliding angle of the droplet is 30° to 40°.

Further, according to at least one aspect of the present disclosure, there is provided a slidable member configured to relatively slide with respect to another member with an oil film that contains a perfluoropolyether in-between, the slidable member having a first surface with which the oil film is brought into contact, and a contact angle of a 1-microliter droplet of a perfluoropolyether having a kinematic viscosity of 500 mm²/s with respect to the first surface at a temperature of 23° C. being 50° to 65°, and a sliding angle of the droplet with respect to the first surface at a temperature of 23° C. being 30° to 40°.

Further features of the present disclosure will become apparent from the following description of exemplary embodiments with reference to the attached drawings.

### DRAWINGS

FIG. 1A and FIG. 1B are schematic views of a heat fixing device according to one or more aspect of the present disclosure, FIG. 1A being a cross-sectional view in an A-C plane and FIG. 1B being a cross-sectional view in a B-C plane.

FIG. 2 is a schematic view for illustrating one mode of a heater having a sliding surface in one or more aspects of the present disclosure.

FIG. 3 is a schematic view for illustrating a sliding device according to one or more aspects of the present disclosure.

FIG. 4A and FIG. 4B are explanatory views of a slidable member according to one or more aspects of the present disclosure, FIG. 4A being a plan view of a sliding surface and FIG. 4B being a cross-sectional view taken along the line A-A′ of FIG. 4A.

### EMBODIMENTS

According to an investigation made by the inventor, the tubular body for fixation according to Japanese Patent Application Laid-Open No. 2004-191744 was effective for the prevention of the depletion of the lubricant. However, the lubricant is repelled at the liquid-repellent finished portion, and hence sliding resistance with the sheet-shaped member was increased at the liquid-repellent finished portion in some cases. Faced with a demand for a further improvement in environmental performance of an electrophotographic image forming apparatus, the inventor has recognized that there is a need to be develop a novel technology capable of achieving a further reduction in sliding resistance while holding the lubricant in the sliding portion over a long period of time. Based on such recognition, the inventor has made further investigations. As a result, the inventor has found that, in the case that two members are arranged so as to be relatively slidable with an oil film in-between, the oil film containing perfluoropolyether, and in the case that at least one surface selected from the group consisting of the members' respective surfaces which are brought into contact with the oil film, satisfies the following conditions, sliding resistance between the two members can be stably kept low over a long period of time. Hereinafter, at least one surface selected from the group consisting of the members' respective surfaces which are brought into contact with the oil film is sometimes referred to as “sliding surface” or “sliding surfaces”.

### <Conditions>

When adhering a 1-microliter droplet of a perfluoropolyether having a kinematic viscosity of 500 mm²/s at an arbitrary position on the at least one surface at a temperature of 23° C., a contact angle of the droplet is 50° to 65°, and a sliding angle of the droplet is 30° to 40°.

The contact angle is a parameter that specifies the wettability of a perfluoropolyether with respect to the sliding surface. Meanwhile, the sliding angle is a parameter that specifies the adherence of a perfluoropolyether onto the sliding surface.

On the sliding surface that satisfies the above-mentioned contact angle, the perfluoropolyether moderately wets and spreads, and hence a thin film of the perfluoropolyether can be stably formed. In addition, on the sliding surface that satisfies the above-mentioned sliding angle, the perfluoropolyether moderately remains, and hence even sliding over a long period of time hardly causes the oil film to be depleted. That is, on the sliding surface on which both of the contact angle and sliding angle of the droplet of the perfluoropolyether satisfy the above-mentioned ranges, a uniform oil film is stably formed by virtue of stable wetting and spreading of the perfluoropolyether. Besides, on the sliding surface, by virtue of a moderate property exhibited by the sliding surface of holding the perfluoropolyether, even sliding over a long period of time hardly causes the oil film to be depleted. Accordingly, when the sliding surface of at least one member selected from the group consisting of two members forming a sliding portion satisfies the above-mentioned conditions, the sliding portion can stably exhibit low friction over a long period of time. The contact angle is preferably 52° to 65°, and the sliding angle is preferably 32° to 40°.

Now, the technical significance of performing the measurement of the contact angle and sliding angle of the sliding surface at a temperature 23° C. using a perfluoropolyether having a kinematic viscosity of 500 mm²/s (500 centistokes (cSt)) is as described below. First, in the sliding portion of a heat fixing device to be used for an electrophotographic image forming apparatus, the temperature of the sliding portion becomes, for example, a high temperature of 200° C. or more. Accordingly, a lubricant containing as a main component a perfluoropolyether, which is chemically stable in the above-mentioned high-temperature environment, and which exhibits excellent lubricity, is used as a lubricant to be applied to the sliding portion. Besides, in order to stably operate the heat fixing device of an electrophotographic image forming apparatus in a process of fixing an electrophotographic image, it is required that the oil film be sufficiently present in the sliding portion even under the high-temperature environment. For that purpose, it is required that the oil film be present in the sliding portion in an environment having normal temperature (a temperature of 23° C.) as well. That is, when the lubricant is held in the sliding portion even during non-operation of the electrophotographic image forming apparatus (heat fixing device), the lubricant can be reliably allowed to be present in the sliding portion during the operation of the electrophotographic image forming apparatus (heat fixing device) as well.

The perfluoropolyether is a polymer including a perfluoroalkylene ether as a repeating unit. Specific examples of the perfluoroalkylene ether include perfluoromethyl ether, perfluoroethyl ether, perfluoropropyl ether, and perfluoroisopropyl ether. The perfluoropolyether to be used for the measurement of the contact angle and the sliding angle is not particularly limited as long as its kinematic viscosity is 500 mm²/s. As a commercially available product of the perfluoropolyether having a kinematic viscosity of 500 mm²/s, there may be given, for example, “Krytox GPL105” (product name, manufactured by The Chemours Company FC, LLC), which has a structure represented by the following structural formula (1).

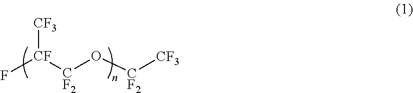

In the structural formula (1), “n” represents an integer of 1 or more.

The sliding surface that satisfies the above-mentioned conditions may be achieved by, for example, a surface having a first phase containing a fluorine atom and a second phase containing an alkyl group having 1 to 10 carbon atoms.

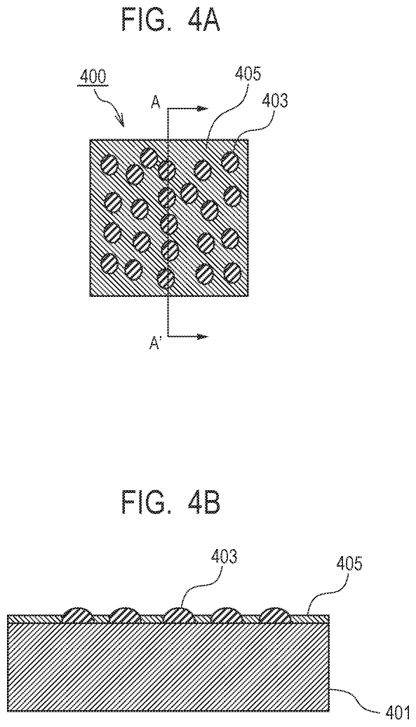

FIG. 4A and FIG. 4B are explanatory views of a slidable member having a sliding surface having first phases and a second phase according to one aspect of the present disclosure. FIG. 4A is a plan view of a slidable member 400 as viewed from the sliding surface side, and FIG. 4B is a cross-sectional view taken along the line A-A′ of FIG. 4A. In the slidable member 400, first phases 403 are present as domains on a surface of a base material 401. In addition, a second phase 405 is present so as to fill gaps between the first phases. Besides, as illustrated in FIG. 4B, the sliding surface of the slidable member 400 is formed of the surfaces of the first phases 403 and the surface of the second phase 405.

The slidable member according to one aspect of the present disclosure is a member to be used for a sliding device, the member being arranged to be opposed to another member across an oil film containing a perfluoropolyether, and being configured to relatively slide with respect to the other member. That is, a sliding device including the slidable member according to one aspect of the present disclosure may adopt, for example, the following case (1), (2), or (3).

Case (1) The slidable member slides against the other member in a static state.
Case (2) The other member slides against the slidable member in a static state.
Case (3) The slidable member and the other member slide against each other.

The first phase containing a fluorine atom has high affinity for the perfluoropolyether. Accordingly, when at least part of the sliding surface is formed of the first phase, the perfluoropolyether can be more easily held on the surface, and the sliding angle of the perfluoropolyether can be increased.

Meanwhile, the perfluoropolyether is repelled at the second phase containing an alkyl group having 1 to 10 carbon atoms. Accordingly, when at least part of the sliding surface is formed of the second phase, the contact angle of the perfluoropolyether with respect to the surface can be increased. That is, by virtue of the presence of the first phase, the perfluoropolyether can be held on the sliding surface. In addition, by virtue of the presence of the second phase, the migration of the perfluoropolyether from the surface can be inhibited.

Accordingly, the contact angle and sliding angle of the perfluoropolyether with respect to the sliding surface can be adjusted by adjusting the area ratios and sizes of the first phase and the second phase on the sliding surface. Besides, in order to better adjust the contact angle and sliding angle according to the present disclosure, it is preferred to have a matrix-domain structure in which the first phases are finely dispersed as domains in a matrix of the second phase. When the sliding surface has the above-mentioned matrix-domain structure, the area ratios and sizes of the first phases and the second phase on the sliding surface are not particularly limited as long as the above-mentioned contact angle and sliding angle are satisfied, but one preferred mode is described below.

That is, when it is assumed that a true circle having a diameter of 1.3 mm is placed at an arbitrary position on the sliding surface, the sum total of the areas of the first phases present in the true circle is preferably 30% to 60%, particularly 40% to 55% with respect to the area of the true circle. In those ranges, low friction can be stably exhibited over a long period of time. This is because the repelling of the perfluoropolyether by the second phase, that is, the friction-lowering effect resulting from a high contact angle, and the holding of the perfluoropolyether by the first phase, that is, the suppression of the leakage of the lubricant and the maintenance of the oil film resulting from a high sliding angle, which are described above, can both be better achieved.

In addition, the average value of the numbers of the first phases present in the true circle is preferably 2,500 to 1,000,000, particularly preferably 5,000 to 1,000,000. Further, the size of each of the first phases in the true circle (domain size) is preferably, for example, 0.5 to 20.0 μm, particularly preferably 1.0 to 15.0 μm. Herein, the “domain size” refers to the diameter of a circle having the same area as the area of a domain observed on the sliding surface (circle-equivalent diameter). The average value of the numbers of the first phases in the true circle is, for example, the arithmetic average value of the numbers of the first phases present in true circles each having a diameter of 1.3 mm placed at ten arbitrary sites on the sliding surface in such a manner as not to overlap each other.

When the area ratio of the first phases in the above-mentioned true circle, the number thereof, and the domain size fall within the above-mentioned ranges, each of the contact angle and the sliding angle of the perfluoropolyether with respect to the sliding surface can be easily controlled to fall within the predetermined numerical range. Accordingly, moderate wetting and spreading of the perfluoropolyether on the sliding surface can be more easily controlled. As a result, a sliding portion capable of stably maintaining satisfactory slidability over a long period of time can be more easily formed.

Next, one mode of a method of forming the sliding surface formed of the first phases and the second phase described above is described below.

First, a member having a surface serving as a base for forming the sliding surface is prepared. For example, the sliding surface according to the present disclosure is arranged on a surface of a biasing member of a heat fixing device to be used for an electrophotographic image forming apparatus, the biasing member being arranged in a fixing belt of an endless shape, the surface being on a side opposed to the inner peripheral surface of the fixing belt. In that case, the surface of the biasing member on the side opposed to the inner peripheral surface of the fixing belt (hereinafter sometimes referred to as “surface to be treated”) is subjected to treatment including the following step (i) and step (ii).

Step (i): Drops of a material for forming the first phases, that is, phases each containing a fluorine atom (hereinafter sometimes referred to as “material for first phase formation”) are caused to adhere onto the surface to be treated to form the first phases.

The material for first phase formation is not particularly limited as long as the material can form the first phases each containing a fluorine atom on the sliding surface. For example, a material having a fluoroalkyl group and being capable of immobilizing the fluoroalkyl group onto the surface to be treated is suitably used. Examples of such material include: a fluorine oil having a perfluoroalkylene ether as a repeating structural unit (hereinafter sometimes referred to simply as “fluorine oil”); a modified perfluoropolyether having a perfluoroalkylene ether structure as a repeating structural unit and having a functional group such as a hydroxy group (hereinafter sometimes referred to as “modified PFPE”); and a silane coupling agent having a perfluoroalkyl group (hereinafter sometimes referred to as “fluorine-based silane coupling agent”).

Specific examples of the perfluoroalkylene ether in the fluorine oil include perfluoromethylene ether (—OCF₂—), perfluoroethylene ether (—OCF₂CF₂—), perfluoropropylene ether (—OCF₂CF₂CF₂—), and perfluoroisopropylene ether (—OCF₂CF(CF₃)—). Such fluorine oil is available as, for example, “Fomblin M60” (product name, manufactured by Solvay Specialty Polymers), “Demnum S-200” (product name, manufactured by Daikin Industries, Ltd.), and “Krytox GPL-107” (product name, manufactured by The Chemours Company FC, LLC).

Examples of the modified PFPE include such modified PFPEs as given below, each having the above-mentioned perfluoroalkylene ether as a repeating unit and having a functional group in the molecule.
Alcohol-modified PFPE having —CH₂OH or —CH₂OCH₂C(OH)HCH₂OH in the molecule; ethoxy alcohol-modified PFPE having —CH₂(OCH₂CH₂)ₙOH in the molecule;
alkoxysilane-modified PFPE having an alkoxysilane, such as —Si(OCH₃)₃ or —Si(OC₂H₅)₃, in the molecule; and
aminosilane-modified PFPE having an aminosilane such as —CONHCH₂Si(OC₂H₅)₃ in the molecule.

Such modified PFPE is available as, for example, “Fluorolink E10-H” and “Fluorolink D4000” (product names, manufactured by Solvay Specialty Polymers), “KY-108” (product name, manufactured by Shin-Etsu Chemical Co., Ltd.), and “MORESCO PHOSFAROL D-40H” (product name, MORESCO Corporation).

An example of the fluorine-based silane coupling agent is one represented by the general formula (I):

Rₘ—Si—Xₙ (I)

where R represents an alkoxy group, “m” represents an integer of from 1 to 3, X represents a functional group having a fluorine atom, and “n” represents an integer of from 1 to 3, provided that m+n=4.

An example of the functional group having a fluorine atom may be a fluoroalkyl group having 1 to 12 carbon atoms, which has high affinity for the perfluoropolyether, in particular, a perfluoroalkyl group having 1 to 10 carbon atoms. When the fluoroalkyl group and the perfluoroalkyl group each have 3 or more carbon atoms, the groups may each be linear or branched.

Examples of the silane coupling agent represented by the general formula (I) may include 3,3,3-trifluoropropyltrimethoxysilane ((CH₃O)₃—Si—CH₂CH₂CF₃), perfluoropropyltrimethoxysilane ((CH₃O)₃—Si—C₃F₇), perfluorohexylethyltriethoxysilane ((CH₃CH₂O)₃—Si—CH₂CH₂C₆F₁₃), perfluorohexylethyltrimethoxysilane ((CH₃O)₃— Si—CH₂CH₂C₆F₁₃), and perfluorodecylethyltriethoxysilane ((CH₃CH₂O)₃—Si—CH₂CH₂C₁₀F₂₁).

Such fluorine-based silane coupling agent is available as, for example, “KBM-7103” (trifluoropropyltrimethoxysilane) (product name, Shin-Etsu Chemical Co., Ltd.), perfluorohexylethyltriethoxysilane and perfluorohexylethyltrimethoxysilane (each of which is manufactured by Uni-chem), and “T2876” (perfluorodecylethyltriethoxysilane) (product name, manufactured by Tokyo Chemical Industry Co., Ltd.) each serving as a silane coupling agent having a fluorinated functional group.

From the viewpoint of an improvement in durability of the first phases in the sliding surface, it is preferred that the first phases be chemically fixed (hereinafter sometimes expressed as “bonded”) to the surface to be treated. For example, the fluorine oil has no functional group, but can be turned into the first phases bonded to the surface to be treated by causing droplets of the fluorine oil to adhere to the surface to be treated, followed, for example, by heating at a temperature of 120° C. for 15 minutes. The reason for this is not clear, but it is conceived that part of the perfluoroalkyl groups in the molecule are cleaved through the heating, and the cleaved sites react with functional groups such as hydroxy groups present on the surface to be treated, to thereby achieve the bonding. The modified PFPE and the fluorine-based silane coupling agent can each be turned into the first phases bonded to the surface to be treated by allowing the functional group in the molecule to react with a functional group such as a hydroxy group present on the surface to be treated. Further, in order to more reliably fix the material for first phase formation to the surface to be treated, it is preferred that surface treatment for introducing a functional group such as a hydroxy group into the surface to be treated or surface treatment for cleaning the surface to be treated be performed prior to the application of the material for first phase formation. As a specific method, there are given, for example, degreasing of the surface to be treated with a solvent, removal of organic matter adhering to the surface to be treated through heating, and surface modification, such as corona discharge, plasma discharge, or UV treatment.

A method of causing drops of the material for first phase formation to adhere to the surface to be treated is not particularly limited, and the first phases may be formed by, for example, a combination of known application methods, such as a spraying method, an inkjet method, screen printing, dipping, bar coating, and brush application. Of those, a spraying method is given as a more preferred example of the method of forming the first phases as domains. When the spraying method is used for the adhesion of the material for first phase formation to the surface to be treated, the sizes and density of the first phases to be formed on the surface to be treated may be adjusted by, for example, appropriately adjusting the viscosity of the material for first phase formation, the ejection pressure thereof, the distance between the tip of a spray nozzle and the surface to be treated, and the ejection amount of the material for first phase formation from the spray nozzle. In addition, the sizes and the density may also be adjusted by appropriately adjusting the relative moving speed of the spray nozzle and the surface to be treated, and the viscosity and concentration of the material for first phase formation. Specifically, for example, an increase in ejection pressure acts in the direction of reducing the sizes of the domains. As the distance between the tip of the spray nozzle and the surface to be treated is reduced more, the droplet impingement range of the surface to be treated becomes smaller, and hence the density of the domains of the first phases can be made higher. However, when the distance is excessively reduced, droplets adhering to the surface to be treated are moved or blown off owing to the influence of atomizing air in some cases. Accordingly, the distance is preferably set to such a distance that the atomizing air does not influence the positions of the droplets adhering to the surface to be treated. In this regard, it is preferred that, as the ejection pressure is increased more, the distance between the tip of the nozzle and the surface to be treated be made longer. A larger ejection amount from the spray nozzle results in larger diameters of droplets to be ejected from the spray nozzle, and hence acts in the direction of making the domain sizes of the first phases larger. A lower relative speed of the spray nozzle and the surface to be treated acts in the direction of making the density of the domains of the first phases higher.

A lower viscosity of the material for first phase formation acts in the direction of making the domain sizes of the first phases smaller. When the viscosity of the material for first phase formation is excessively low, after droplet impingement on the surface to be treated, the droplets on the surface to be treated move, sometimes leading to coalescence between the droplets. As a result, the domain sizes of the first phases may become nonuniform. As an example, when the spraying method is used for the adhesion of the material for first phase formation to the surface to be treated, the absolute viscosity of the material for first phase formation is preferably set to 1 to 2 mPa·s.

Similarly, a lower concentration of the material for first phase formation acts in the direction of making the domain sizes of the first phases smaller. However, when the concentration of the material for first phase formation is excessively low, the number of times of application needs to be increased in order to increase the density of the first phases.

For example, when a solvent is incorporated into the material for first phase formation to adjust its viscosity, it is preferred to select a solvent that evaporates (vaporizes) before the droplets from the spray nozzle impinge on the surface to be treated. When the solvent has volatilized by the time the droplets impinge on the surface to be treated, the droplets hardly flow on the surface to be treated after the droplet impingement, which is advantageous for achieving further uniformization of the domain sizes of the first phases.

Step (ii): This step is a step of forming the second phase.

In this step, a material for second phase formation is prepared, and the material for second phase formation is caused to adhere onto a surface, which is not covered with the first phases, in the surface to be treated, to thereby form the second phase.

Next, the material to be used for the second phase according to this embodiment is exemplified. It is preferred that the material for second phase formation have high oil repellency against a perfluoropolyether, and have an alkyl group having 1 to 10 carbon atoms. Examples of the material for second phase formation include a silicone oil such as dimethylpolysiloxane, a modified silicone oil having a reactive group, and an alkylalkoxysilane coupling agent.

Dimethylpolysiloxane is a polysiloxane in which all side chains and ends are methyl groups (carbon number: 1). Dimethylpolysiloxane can be immobilized onto the surface of a substance through baking treatment, and can repel a perfluoropolyether contained in the lubricant because its methyl groups align themselves to face outward.

From the viewpoint of being able to be more easily immobilized onto the exposed surface of the sliding portion, the modified silicone oil having a reactive group is preferred as the material for second phase formation. Of those, a methyl hydrogen silicone oil having a silanol group (—SiH), which can be more reliably immobilized onto a glass surface, may be particularly suitably used.

An example of the alkylalkoxysilane coupling agent that may be used as the material for second phase formation in this embodiment is one represented by the general formula (II):

(CₚH₂ₚ₊₁)ₘ—Si—(OC_{q}H_{2q+1})ₙ (II)

where CₚH₂ₚ₊₁ represents an alkyl group, “p” represents an integer of 1 or more and 10 or less, OC_{q}H_{2q+1} represents an alkoxy group, and “q” represents an integer of 1 or more and 3 or less. “m” represents an integer of from 1 to 3, and “n” represents an integer of from 1 to 3, provided that m+n=4.

When “p” in the formula (II) is increased, the contact angle is reduced, and hence “p” is set to 10 or less. Further, when “q” represents more than 3, the reactivity of the silane coupling agent is reduced, and hence the covering of the sliding surface with the material for second phase formation is less likely to be sufficiently performed. It is desired to use an alkylalkoxysilane coupling agent in which “p” in the formula (II) preferably represents an integer of 1 to 5 and “q” therein preferably represents an integer of 1 or 2.

Examples of the silane coupling agent represented by the general formula (II) may include methyltrimethoxysilane, dimethyldimethoxysilane, n-propyltrimethoxysilane, hexyltrimethoxysilane, decyltrimethoxysilane, methyltriethoxysilane, dimethyldiethoxysilane, n-propyltriethoxysilane, hexyltriethoxysilane, and octyltriethoxysilane.

When the above-mentioned silane coupling agents are used, treatment may be performed using the silane coupling agents alone or in combination thereof. When the silane coupling agents are used in combination thereof, treatment may be performed with each of the silane coupling agents separately, or treatment may be performed with the silane coupling agents simultaneously.

The following are given as commercially available products (all of which are referred to by product names) of materials suitable as the material for second phase formation:
dimethylpolysiloxanes, such as KF-96-100cs and KF-965-1,000 cs (each of which is manufactured by Shin-Etsu Chemical Co., Ltd.), and DOWSIL SH 200 Fluid 2,000 cSt and DOWSIL SH 200 CV Fluid 13,000 cSt (each of which is manufactured by Dow Corning Toray Co., Ltd.);
modified silicone oils, such as KF-99 and KF-9901 (each of which is manufactured by Shin-Etsu Chemical Co., Ltd.); and
alkylalkoxysilane coupling agents, such as KBE-13 (methyltriethoxysilane), KBE-22 (dimethyldiethoxysilane), KBE-103 (phenyltriethoxysilane), KBE-3083 (octyltriethoxysilane), and KBM-13 (methyltrimethoxysilane) (each of which is manufactured by Shin-Etsu Chemical Co., Ltd.), XIAMETER OF S-6366 Silane (methyltrimethoxysilane) and XIAMETER OF S-6383 Silane (methyltriethoxysilane) (each of which is manufactured by Dow Toray Co., Ltd.), and M0451 (methyltrimethoxysilane) (manufactured by Tokyo Chemical Industry Co., Ltd.).

A method of applying the material for second phase formation onto the surface to be treated is not particularly limited, and the second phase may be formed by a combination of known application methods, such as spray coating, inkjet printing, screen printing, dipping, bar coating, and brush application. At this time, the material for second phase formation may be selectively applied only to the surface, which is not covered with the first phases, in the surface to be treated (hereinafter sometimes referred to as “exposed surface”). In addition, the material for second phase formation may be applied so as to cover not only the surface, which is not covered with the first phases, in the surface to be treated, but also the surfaces of the first phases. In this case, the first phases may be exposed by adjusting the physical properties of the material for second phase formation so as to be repelled on the surfaces of the first phases. In addition, the first phases may be exposed by removing the material for second phase formation adhering onto the first phases with a solvent.

Here, when the spraying method is used for the adhesion of the material for second phase formation to the surface to be treated, the absolute viscosity of the material for second phase formation is preferably set to, for example, 1 to 2 mPa·s. In addition, when the adhesion of the material for second phase formation to the surface to be treated is performed by the brush application, the absolute viscosity of the material for second phase formation is preferably set to, for example, 1,000 to 10,000 mPa·s. Further, when the adhesion of the material for second phase formation to the surface to be treated is performed by the dipping method, the absolute viscosity of the material for second phase formation is preferably set to, for example, 10,000 to 1,000,000 mPa·s.

Here, the second phase is preferably bonded to the exposed surface of the surface to be treated as with the first phases. This is because the durability of the second phase in the sliding surface can be improved. A method similar to that in the case of the first phases may be used as a method for the bonding. When the material for second phase formation is applied so as to cover the exposed surface of the surface to be treated and the surfaces of the first phases as well, treatment for immobilizing the material for second phase formation onto the exposed surface may be performed after the removal of an excess of the material for second phase formation covering the first phases. Alternatively, the treatment for immobilizing the material for second phase formation onto the exposed surface may be performed before the removal of the excess of the material for second phase formation covering the first phases, followed by the removal of the material for second phase formation that is not fixed to the exposed surface.

Next, a heat fixing device according to a preferred embodiment of the present disclosure is described in detail with reference to schematic drawings. The present disclosure is not limited to the following embodiment, and may be variously applied and carried out within the scope of the technical spirit of the present disclosure.

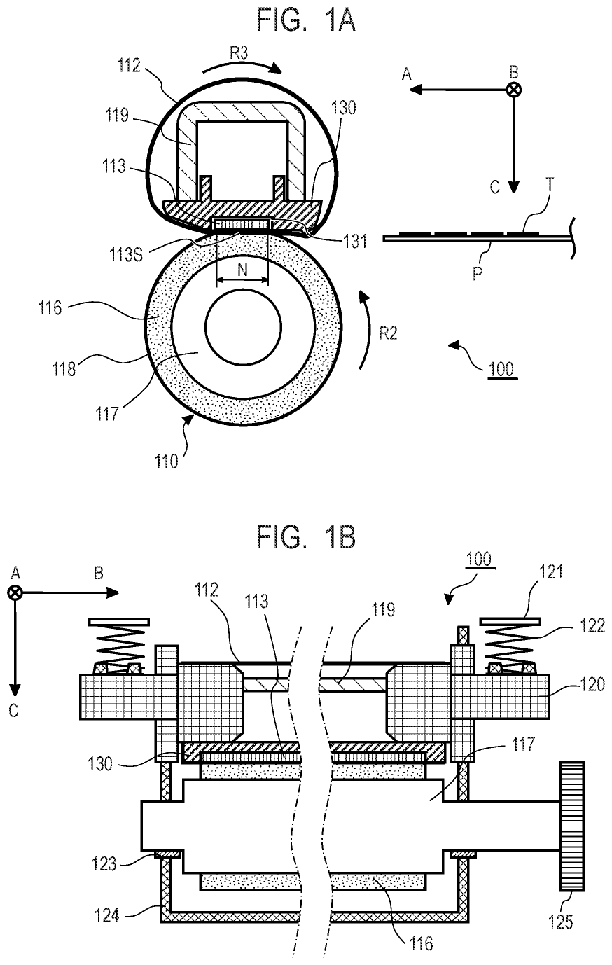

Schematic cross-sectional views of a heat fixing device 100 according to one embodiment of the present disclosure are illustrated in FIG. 1A and FIG. 1B.

The heat fixing device 100 is a heat fixing device of a film heating system excellent in shortening of a start-up time and lowering of power consumption. In the following description, the shapes, arrangement, dimensions, and the like of members related to the heat fixing device 100 are expressed using a conveyance direction A of a recording material, a longitudinal direction B, and a perpendicular direction C. FIG. 1A is a cross-sectional view for illustrating an appearance of the heat fixing device 100 cut along a plane (A-C plane) perpendicular to the longitudinal direction B, and FIG. 1B is a cross-sectional view for illustrating an appearance of the heat fixing device 100 cut along a plane (B-C plane) parallel to the longitudinal direction B.

The conveyance direction A is the conveyance direction of a recording material P at a nip portion (a fixing nip N described below) of the heat fixing device 100. The longitudinal direction B is the longitudinal direction of the fixing nip N, and is the width direction of the recording material P passing through the fixing nip N (direction orthogonal to the recording material conveyance direction A). The perpendicular direction C is a direction perpendicular to the surface of the recording material P at the fixing nip N. The perpendicular direction C is also a direction in which a heater 113 pressurizes a pressure roller 110 via a fixing film 112 at the fixing nip N.

The heat fixing device 100 includes the fixing film 112, the heater 113, a heater holder 130, a pressurizing stay 119, and the pressure roller 110. A region in which the pressure roller 110 and the fixing film 112 are brought into contact with each other is defined as the fixing nip N. The heater 113 is held by the heater holder 130. The heater 113 and the heater holder 130 form a nip forming unit for forming the fixing nip N capable of sandwiching the recording material P together with the pressure roller 110 serving as a pressurizing member. The fixing film 112, which is a cylindrical (belt-shaped) member (rotatable first member), is arranged around the nip forming unit. The rotatable first member has an outer peripheral surface and an inner peripheral surface. The heater 113 is arranged on the inner peripheral surface side of the rotating fixing film 112, and heats the fixing film 112 from the inside. In addition, the heater 113 has an opposed surface to the inner peripheral surface of the fixing film 112. An oil film (not shown) containing a perfluoropolyether is present between the inner peripheral surface of the fixing film 112 and the opposed surface of the heater 113, and the opposed surface of the heater 113 forms a sliding surface against the inner peripheral surface of the rotating fixing film 112. In addition, the heater 113 forms part of a biasing member configured to bias the fixing film 112 toward the pressure roller 110. In the longitudinal direction B, a range in which the heater 113 slides with the fixing film 112 is defined as a film contact region. The heater holder 130 extends to the upstream side and downstream side of the heater 113 in the recording material conveyance direction A, and has a guide function of guiding the rotation (running) of the fixing film 112. In FIG. 1B, projections are arranged on the carry-in side of the recording material to increase the nip width, and to control the entry direction of the recording material from the lower side of the drawing sheet to the upper side, but the configuration of the heat fixing device is not limited thereto.

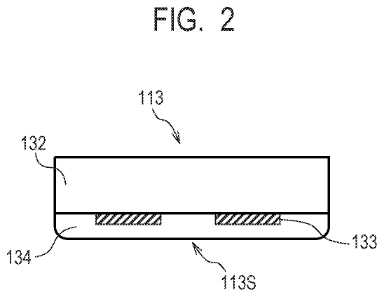

As illustrated in a schematic cross-sectional view of in FIG. 2, the heater 113 may be a laminated structural body. The heater 113 is a general heater capable of heating to be used in a heat fixing device of a film heating system, and there is used a heater obtained by arranging a resistance heating element 133 on a substrate 132 made of a ceramic, and arranging glass serving as a protective layer 134 thereon. The heater 113 of this embodiment includes a substrate made of alumina having a width in the recording material conveyance direction A of 6 mm and a thickness in the perpendicular direction C of 1 mm. The heater 113 may be, for example, a heater obtained by applying a resistance heating element made of silver-palladium (Ag/Pd) at a thickness of about 10 μm to the surface of the substrate by screen printing, and covering the resultant from above with glass having a thickness of 60 μm for protecting the heating element. In addition, a heat equalizing member having high thermal conductivity may be arranged on the back surface of the heater 113 in accordance with an application. In addition, the temperature of the heater 113 is adjusted by appropriately controlling a current to be caused to flow through the resistance heating element in accordance with a signal from a temperature detecting element (not shown) configured to detect the temperature of the ceramic substrate or the fixing film 112. The heater 113 is supported (held) by the heater holder 130 by being fixed to the heater holder 130 in a state of being fitted into a fitting groove 131 arranged in the heater holder 130. In this embodiment, in order to efficiently transfer heat to the recording material P, the center (rotation axis) of the heater 113 and the center (rotation axis) of the pressure roller 110 are aligned in the recording material conveyance direction A. A metal substrate made of stainless steel or the like may be used as the substrate 132 of the heater 113. In that case, an insulating layer made of glass or the like is formed on the substrate, and the resistance heating element is formed on the insulating layer.

An opposed surface 113S of the heater 113, which is to be opposed to the inner peripheral surface of the fixing film 112, is the sliding surface having the predetermined contact angle and sliding angle according to one aspect of the present disclosure. That is, on the sliding surface 113S and at a temperature of 23° C., a 1-microliter droplet of a perfluoropolyether having a kinematic viscosity of 500 mm²/s has a contact angle of 50° to 65°, and the droplet has a sliding angle of 30° to 40°. The opposed surface 113S is a surface on the pressure roller 110 side in the perpendicular direction C.

An oil film containing a perfluoropolyether is interposed between the opposed surface 113S and the inner peripheral surface of the fixing film 112. In addition, along with the rotation of the fixing film 112, the inner peripheral surface of the fixing film 112 slides on the opposed surface 113S of the heater 113.

Fluorine grease for forming the oil film contains, for example, a base oil and a thickener.

<Base Oil>

The base oil includes, for example, a fluorine oil such as a perfluoropolyether (PFPE). As described above, the perfluoropolyether is a polymer including a perfluoroalkylene ether as a repeating unit. Specific examples of the perfluoroalkylene ether include perfluoromethyl ether, perfluoroethyl ether, perfluoropropyl ether, and perfluoroisopropyl ether. For the base oil to be used for the fluorine grease to be used for the sliding portion of the heat fixing device, which is brought to high temperature, it is preferred from the viewpoint of heat resistance to use a perfluoropolyether having only carbon atoms, fluorine atoms, and oxygen atoms as constituent atoms, and having a chemical structure in which these atoms are bonded by single bonds.

Here, the perfluoropolyether in the fluorine grease has a kinematic viscosity at a temperature of 23° C. in preferably the range of from 200 mm²/s to 1,500 mm²/s, particularly preferably the range of from 200 mm²/s to 600 mm²/s. When the kinematic viscosity of the perfluoropolyether in the fluorine grease falls within the above-mentioned ranges, the leakage of the fluorine grease from the sliding portion of the heat fixing device during non-operation of an electrophotographic image forming apparatus can be more reliably prevented. In addition, the leakage of the fluorine grease from the sliding portion in the case where the heat fixing device is brought to high temperature during the operation of the electrophotographic image forming apparatus can also be more reliably prevented. The measurement of the kinematic viscosity of a perfluoropolyether may be performed by a method described in Examples to be described later. Here, the kinematic viscosity of the perfluoropolyether contained in the fluorine grease can be measured by measuring the perfluoropolyether which is centrifugally extracted from the fluorine grease. The fluorine grease may be diluted with diluent in order to more easily precipitate the thickener at the time of centrifugation. Examples of the diluent include hydrofluoroether such as “NOVEC7300” manufactured by 3M. For example, the thickener in the fluorine grease can be easily precipitated by diluting the fluorine grease with “NOVEC7300” by a factor of 2, and then centrifuging the diluted fluorine grease in accordance with the following conditions:

### <Conditions for Centrifugation>

Unit: High Speed Centrifuge model 7780 manufactured by KUBOTA Cooperation;
Rotor type: angle rotor A-224;
Capacity of sample tube: 1.5 ml;
Number of revolutions: 20000 rpm;
Relative centrifugal force: 36670×g;

### Temperature: 40° C.

Centrifugation duration: 30 minutes.
In the case that the diluent is used, it is preferable to remove the diluent from a supernatant including the perfluoropolyether resulting from the centrifugation prior to measuring the kinematic viscosity. The diluent can be removed from the supernatant by way of, for example, heating and decompression.

An example of the perfluoropolyether that may be used for the fluorine grease may be at least one perfluoropolyether selected from the group consisting of: a perfluoropolyether having the structure represented by the above-mentioned structural formula (1); a perfluoropolyether having a structure represented by the following structural formula (2); a perfluoropolyether having a structure represented by the following structural formula (3); and a perfluoropolyether having a structure represented by the following structural formula (4).

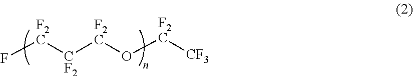

In the structural formula (2), “n” represents a positive integer.

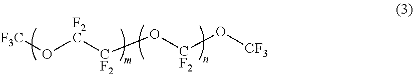

In the structural formula (3), “m” and “n” each independently represent a positive integer.

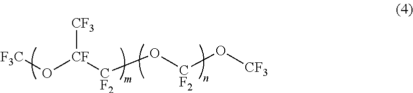

In the structural formula (4), “m” and “n” each independently represent a positive integer.

Commercially available products may be used as the perfluoropolyethers having the structures represented by the structural formulae (1) to (4). For example, examples of the perfluoropolyether having the structure represented by the structural formula (1) include “Krytox GPL-107”, “Krytox GPL-106”, and “Krytox GPL-105” (product names, manufactured by Chemours Company).

In addition, examples of the perfluoropolyether having the structure represented by the structural formula (2) include “Demnum S-200” and “Demnum S-65” (product names, manufactured by Daikin Industries, Ltd.).

In addition, examples of the perfluoropolyether having the structure represented by the structural formula (3) include “Fomblin M30” and “Fomblin Z25” (product names, manufactured by Solvay Specialty Polymers). Further, examples of the perfluoropolyether having the structure represented by the structural formula (4) include “Fomblin Y45” and “Fomblin Y25” (product names, manufactured by Solvay Specialty Polymers).

In addition, examples of the thickener include powders of fluorine resins such as polytetrafluoroethylene (PTFE). A preferred example of the fluorine grease is fluorine grease containing PFP as the base oil and PTFE powder as the thickener. The content of the base oil in the fluorine grease is preferably 50 to 90 mass %, particularly preferably from 60 to 85 mass % with respect to the total mass of the fluorine grease.

In addition, the consistency of the fluorine grease is not particularly limited, but for example, its consistency at a temperature of 25° C. measured by a method specified in Japan Industrial Standard (JIS) K2220:2013 falls within preferably the range of from 220 to 385, particularly preferably the range of from 265 to 340. When the consistency of the fluorine grease falls within the above-mentioned ranges, the driving torque of the heat fixing device during the operation of the electrophotographic image forming apparatus can be more reliably prevented from becoming excessively large. In addition, the leakage of the fluorine grease from the sliding portion during the operation of the heat fixing device can be more reliably prevented.

Commercially available fluorine grease may be used as such fluorine grease. An example thereof is “MOLYKOTE HP-300” (product name, manufactured by DuPont Toray Specialty Materials K.K., consistency at a temperature of 25° C. based on JIS K2220:2013: from 265 to 295).

The fluorine grease is preferably applied over a slightly shorter region in the sliding surface 113S of the heater 113 than the width of the pressurized region of the pressure roller 110 in the longitudinal direction B. In this embodiment, the pressurized region was 220 mm, and hence a margin of 5 mm was arranged at each of both end portions in the longitudinal direction B, and 200 mg of the fluorine grease was applied by spray application. The fluorine grease applied to the sliding surface 113S spreads over the whole circumference of the inner peripheral surface of the fixing film 112 along with the rotation of the pressure roller 110 and the fixing film 112. In addition, an oil film (not shown) made of the fluorine grease is formed on the sliding surface 113S.

The outer peripheral surface of the pressure roller 110 is arranged to be opposed to the outer peripheral surface of the fixing film 112, is biased by the heater 113 and the heater holder 130 across the fixing film 112, and is brought into pressure contact with the fixing film 112 at the fixing nip N. The pressure roller 110 is an example of the pressurizing member (rotatable second member), and for example, a belt unit, which includes a plurality of rollers including a roller to be opposed to the fixing nip, and a belt member tensioned on the plurality of rollers, may be used as the pressurizing member. In that case, it is appropriate that a biasing member to be brought into contact with the inner peripheral surface of the pressurizing belt be arranged at the fixing nip N, and that an urging force with the biasing member in the fixing film 112 be adjusted so as to achieve a predetermined pressurizing force at the fixing nip N.

The pressure roller 110 includes a mandrel 117 (FIG. 1B), and both end portions of the mandrel 117 are rotatably held by a fixing frame 124 via bearings 123. The mandrel 117 may have a solid cylindrical shape, or may have a hollow cylindrical shape, but in this embodiment, a mandrel having a solid cylindrical shape and having a shaft portion grinded was used. In addition, the pressure roller 110 is connected to a driving source (rotation unit) (not shown) via a driving gear 125 arranged at the shaft end portion of the mandrel 117, and is driven in the arrow R2 direction of FIG. 1A by a driving force from the driving source. The fixing film 112 is driven to rotate by the rotation of the pressure roller 110 in the arrow R3 direction by a frictional force received from the pressure roller 110 at the fixing nip N.

When the recording material P onto which an unfixed toner image T has been transferred is conveyed to the fixing nip N in the recording material conveyance direction A, the recording material P is conveyed while being sandwiched between the fixing film 112 and the pressure roller 110 at the fixing nip N. During the passage of the recording material P through the fixing nip N, the unfixed toner image T is pressurized, and the heat of the heater 113 is transferred to the unfixed toner image T via the fixing film 112. Thus, the toner of the unfixed toner image T melts, and solidifies after passing through the fixing nip N, to thereby provide a fixed image fixed to the surface of the recording material P.

The fixing film 112 is a cylindrical member (endless belt-shaped member) having flexibility, and has a multilayer structure in its thickness direction. The layer configuration of the fixing film 112 includes a base layer for keeping the strength of the film, and a release layer for reducing surface fouling. A material for the base layer is required to have heat resistance for receiving the heat of the heater 113, and is also required to have strength for sliding with the heater 113 or the like, and hence a metal, such as stainless steel or nickel, or a heat-resistant resin such as polyimide is suitably used. In this embodiment, a polyimide resin was used as the material for the base layer of the fixing film 112, and a carbon-based filler was added and used to improve thermal conductivity and strength. As the thickness of the base layer becomes smaller, it becomes easier for the heat of the heater 113 to be transferred to the surface of the pressure roller 110, but the strength becomes lower, and hence the thickness is preferably from about 15 to about 100 In this embodiment, the fixing film 112 was set to have, in an undeformed cylindrical state, a length in the longitudinal direction B of 233 mm, an outer diameter of 18 mm, and a thickness of the base layer of 60 μm.

A fluorine resin is preferably used as a material for the release layer of the fixing film 112. Examples of the fluorine resin include a copolymer of tetrafluoroethylene (hereinafter referred to as “TFE”) and a perfluoroalkyl vinyl ether (hereinafter referred to as “PAVE”) (hereinafter also referred to as “PFA”), polytetrafluoroethylene (PTFE), and a tetrafluoroethylene-hexafluoropropylene copolymer (FEP). Examples of the PAVE include perfluoromethyl vinyl ether (CF₂═CF—O—CF₃), perfluoroethyl vinyl ether (CF₂═CF—O—CF₂CF₃), and perfluoropropyl vinyl ether (CF₂═CF—O—CF₂CF₂CF₃). In this embodiment, PFA excellent in releasability and heat resistance among fluorine resins was used as the release layer. The release layer may be one obtained by covering the outer periphery of the base layer with a tube, but may also be one obtained by coating the surface of the base layer with a coating material. In this embodiment, the release layer was formed of a coat excellent in thin-wall molding. As the thickness of the release layer becomes smaller, it becomes easier for the heat of the heater 113 to be transferred to the surface of the fixing film 112. However, when the thickness is excessively small, durability is reduced. Accordingly, the thickness is preferably from about 5 μm to about 30 μm, and in this embodiment, was set to 10 μm. Although not used in this embodiment, an elastic layer may be arranged between the base layer and the release layer. In that case, a silicone rubber, a fluorine rubber, or the like is used as a material for the elastic layer.

The heater holder 130 serving as a holding member configured to hold the heater 113 is arranged on the inner peripheral side of the fixing film 112. The heater holder 130 has a gutter shape having a recess of an approximately rectangular shape opened on the pressure roller 110 side (fixing nip N side) in the perpendicular direction C in the A-C cross-section, and extends in the longitudinal direction B. The recess is the fitting groove 131 which extends in the longitudinal direction B, and to which the heater 113 is fitted. The heater holder 130 has a cross-sectional shape that extends in an approximately semicircular shape along the inner peripheral surface of the fixing film 112 on the upstream side and downstream side of the fixing nip N (both sides of the fitting groove 131) in the recording material conveyance direction A. In addition, the heater holder 130 is formed of a liquid crystal polymer resin having high heat resistance in order to satisfy heat resistance and rigidity. In this embodiment, a wholly aromatic polyester SUMIKASUPER (trademark) manufactured by Sumitomo Chemical Industry Company Limited is used as the liquid crystal polymer resin. In addition, the heater holder 130 is configured to hold the heater 113, but also serves to guide the rotation of the fixing film 112 by externally fitting the fixing film 112 loosely around the heater holder 130.

The pressurizing stay 119 extends along the heater holder 130 in the longitudinal direction B. The pressurizing stay 119 is formed of a product obtained by subjecting a sheet metal having high rigidity, such as stainless steel, to bending processing in order to uniformly pressurize approximately the whole area of the heater holder 130 in the longitudinal direction B toward the pressure roller 110.

As illustrated in FIG. 1B, fixing flanges 120 serving as flange members are fitted to both end portions of the pressurizing stay 119 in the longitudinal direction B. The fixing flanges 120 guide (support) the rotation orbit of the fixing film 112, and also serve to regulate the positions of the end portions of the fixing film 112 in the longitudinal direction B (deviation regulation), and to transmit a pressurizing force to the pressurizing stay 119. That is, each of the fixing flanges 120 is connected to a spring 122, which is an example of an urging unit configured to bias the fixing film 112, at the fixing nip N. The spring 122 is supported by a spring supporting part 121 fixed to the fixing frame 124 serving as the frame member of the fixing device 100, to thereby bias the fixing flange 120 toward the pressure roller 110 side in the perpendicular direction C. Thus, the pressurizing stay 119 connected to the fixing flanges 120 is biased toward the pressure roller 110 side, and the heater holder 130 and the heater 113 pressed by the pressurizing stay 119 bring the fixing film 112 into pressure contact with the pressure roller 110. The pressurizing force to be applied to the fixing nip N is set to, for example, 137.4 N (14 kgf) in terms of total pressure.

The pressure roller 110 according to this embodiment has an elastic layer 116 formed on the outer periphery of the mandrel 117. A solid rubber or a foamed rubber is used as a material for the elastic layer 116. The foamed rubber has a low heat capacity and low thermal conductivity, and hence has the following advantage: the heat of the surface of the pressure roller 110 is hardly absorbed into the inside, and hence its surface temperature can easily increase to shorten a fixing start-up time. The fixing start-up time or warm-up time is a period of time required for the temperature of the fixing film 112 at the fixing nip N to reach a predetermined target temperature suited for the fixing of an image after the start of energization of the heater 113 from a state in which the energization is not performed. As the mandrel 117, there may be used, for example, a mandrel made of iron having a length of an elastic layer-formed portion of 220 mm and a diameter of 15 mm. In addition, a foamed rubber obtained by foaming a silicone rubber may be used as the elastic layer 116.

As the outer diameter of the pressure roller 110 becomes smaller, its heat capacity can be reduced more. However, when the outer diameter is excessively small, the width of the fixing nip N becomes small. For this reason, a moderate diameter is desired. With regard to the thickness of the elastic layer 116, when the thickness is excessively small, heat escapes to the mandrel made of metal, and hence a moderate thickness is preferred. In this embodiment, for example, the thickness of the elastic layer 116 is set to 2.5 mm, and the outer diameter of the pressure roller 110 is set to 20 mm. A release layer 118 formed of PFA may be formed as a toner release layer on the elastic layer 116. Like the release layer of the fixing film 112, the release layer 118 may be one obtained by coverage with a tube, or may be one obtained by coating the surface with a coating material. In addition, a tube excellent in durability may be used. Besides PFA, for example, a fluorine resin, such as PTFE or FEP, or a fluorine rubber or silicone rubber having good releasability may be used as the material for the release layer 118. As the surface hardness of the pressure roller 110 becomes lower, a larger width of the fixing nip N is obtained because of a lighter pressure. In this embodiment, a pressure roller having a surface hardness of 50° in terms of Asker-C hardness (hardness measured with a type C durometer at a load of 4.9 N) was used. In this embodiment, the width of the fixing nip N in the recording material conveyance direction A is about 6.0 mm throughout the whole area of the fixing nip N in the longitudinal direction B. The pressure roller 110 is configured to be rotated by a driving source (not shown) in the arrow R2 direction in FIG. 1A at a surface moving speed of 266 mm/sec.

The present disclosure has been described above by taking as an example the embodiment of such heat fixing device as illustrated in FIG. 1A and FIG. 1B, but the present disclosure is not to be construed as limited to the above-mentioned embodiment. Needless to say, various alterations, modifications, and improvements may be made within the scope described in the present disclosure, and may be realized within the scope in which the features of the present disclosure are satisfied.

For example, in the heat fixing device illustrated in FIG. 1A and FIG. 1B, the heater 113 doubles as the biasing member. However, the heater configured to heat the fixing film, and the biasing member, which is brought into sliding contact with the fixing film, and is configured to bias the fixing film toward the pressure roller, may be separate members. For example, there is given a heat fixing device in which a material capable of generating heat through induction heating is used as a base material for the fixing film, and in which an induction heating coil arranged at a portion other than the nip portion is used for the fixing film. In such heat fixing device, the following configuration may be adopted: a biasing member including no heater and having an opposed surface to the inner peripheral surface of the fixing film is arranged inside the fixing film to bias the fixing film 112 with respect to the pressure roller 110. In such heat fixing device, the opposed surface of the biasing member including no heater and having the opposed surface to the inner peripheral surface of the fixing film may be used as the sliding surface according to the present disclosure.

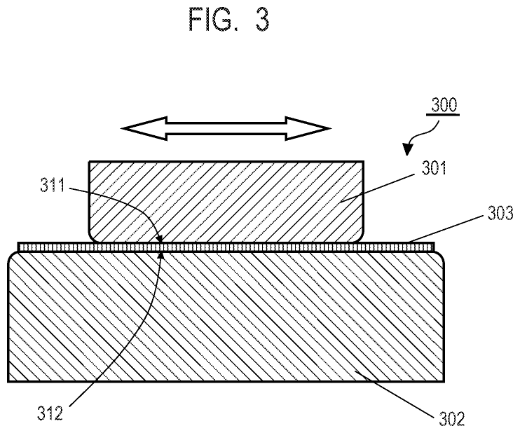

FIG. 3 is a conceptual view for illustrating a sliding device according to another embodiment of the present disclosure. The sliding device includes a first member 301 and a second member 302, which are brought into contact with each other in a relatively slidable manner via an oil film 303. The oil film 303 contains a perfluoropolyether. The first member 301 has a first surface 311 opposed to the second member 302, and the second member 302 has a second surface 312 opposed to the first member 301. At least one surface selected from the group consisting of: the first surface; and the second surface satisfies the following conditions.

### <Conditions>

One microliter of a perfluoropolyether having a viscosity of 500 mm²/s at a temperature of 23° C. is dropped onto an arbitrary position on the at least one surface, and the contact angle and sliding angle of the droplet of the perfluoropolyether are measured at a temperature of 23° C. In this case, the contact angle is 50° to 65°, and the sliding angle is 30° to 40°.

The sliding device is not particularly limited as long as the sliding device is one in which two members are slidably held via an oil film. As described in the above-mentioned embodiment, when the above-mentioned conditions are satisfied, the leakage of the oil film between the members is suppressed, and hence low friction can be stably exhibited over a long period of time.

The surface that satisfies the above-mentioned conditions is also called a sliding surface as in the above-mentioned embodiment of the present disclosure, and may be formed of, for example, the surface having the first phase and the second phase described above. Besides, the sliding surface having the first phase and the second phase may be formed, as described above, by a method involving using a material for first phase formation and a material for second phase formation.

According to one aspect of the present disclosure, the heat fixing member capable of stably exhibiting low friction over a long period of time can be provided. In addition, according to another aspect of the present disclosure, the sliding device capable of stably exhibiting low friction over a long period of time can be provided. Further, according to another aspect of the present disclosure, the slidable member capable of stably exhibiting low friction over a long period of time can be provided.

### EXAMPLES

Now, the heat fixing device according to one aspect of the present disclosure is specifically described by way of Examples and Comparative Examples. The heat fixing device according to the present disclosure is not limited to the configuration embodied in Examples.

First, the following commercially available products were prepared for the preparation of materials for first phase and second phase formation.

<Preparation of Materials D-1 to D-4 for First Phase Formation>

Material D-1 for First Phase Formation;

A fluorine oil “Fluorolink D4000” (product name, manufactured by Solvay Specialty Polymers) was diluted with a fluorine solvent “Novec 7300” (product name, manufactured by 3M Company) to prepare a 5 wt % solution of the fluorine oil. The solution was used as a material D-1 for first phase formation.

Materials D-2 and D-3 for First Phase Formation;

Materials D-2 and D-3 for first phase formation were prepared in the same manner as the material D-1 for first phase formation except that “Fomblin M60” (product name, manufactured by Solvay Specialty Polymers) or “MORESCO PHOSFAROL D-40H” (product name, manufactured by MORESCO Corporation) was used as the fluorine oil.

Material D-4 for First Phase Formation;

A fluorine-modified silane coupling agent (“T2876” (product name, manufactured by Tokyo Chemical Industry Co., Ltd.)) was diluted 5-fold with an aqueous alcohol solution (water/alcohol=1 in parts by weight/9 in parts by weight) to prepare a material D-4 for first phase formation.

<Preparation of Materials M-1 to M-3 for Second Phase Formation>

Material M-1 for Second Phase Formation;

Dimethylpolysiloxane “KF-965-1,000cs” (product name, manufactured by Shin-Etsu Chemical Co., Ltd.) was used as it was as a material M-1 for second phase formation.

Material M-2 for Second Phase Formation;

As a modified silicone oil, a methyl hydrogen silicone oil “KF-99” (product name, manufactured by Shin-Etsu Chemical Co., Ltd.) was used as it was as a material M-2 for second phase formation.

Material M-3 for Second Phase Formation;

Phenyltriethoxysilane “KBE-103” (product name, manufactured by Shin-Etsu Chemical Co., Ltd.) was diluted 5-fold with an aqueous alcohol solution (water/alcohol=1 in parts by weight/9 in parts by weight) to prepare a material M-3 for second phase formation.

For each of the prepared solutions, the viscosity according to the present disclosure was measured under the following conditions. Because of the torque detection range of the apparatus, a shear rate at which the measurement was performed was changed in accordance with a viscosity range.

Apparatus name: accurate rotary rheometer “RST-SST” (product name, manufactured by Brookfield)
Spindle: CCT-25 (sample amount: 16.8 mL)
Shear rate: (viscosity: from 1 mPa·s to 1,000 mPa·s) 1,000 s⁻¹
(viscosity: from 100 mPa·s to 10,000 mPa·s) 100 s⁻¹
(viscosity: from 1,000 mPa·s to 100,000 mPa·s) 10 s⁻¹
(viscosity: from 10,000 mPa·s to 1,000,000 mPa·s) 1 s⁻¹
   Measurement time: 30 sec
   Controlled temperature: 25° C.

The viscosities of the materials D-1 to D-4 for first phase formation and the materials M-1 to M-3 for second phase formation are shown in Table 1.

TABLE 1

| | Viscosity |
|---|---|
| Kind of material | (mPa · s) |
| D-1 | 1.22 |
| D-2 | 1.24 |
| D-3 | 1.25 |
| D-4 | 1.63 |
| M-1 | 974,000 |
| M-2 | 19,800 |
| M-3 | 1.82 |

Heating at 200° C. for 15 minutes was performed for baking. Heating at 100° C. for 10 minutes was performed for the removal of the solvent used for spray coating, and heating at 120° C. for 15 minutes was performed for immobilization.

### Example 1

A heater having the configuration illustrated in FIG. 2, which had the sliding surface according to the present disclosure, was produced using D-1 as a material for first phase formation and M-1 as a material for second phase formation.

The substrate 132 made of alumina illustrated in FIG. 2, having a width in the recording material conveyance direction A of 6 mm and a thickness in the perpendicular direction C of 1 mm, was prepared. The resistance heating element 133 made of silver-palladium (Ag/Pd) was applied at a thickness of 10 μm onto the substrate by screen printing. Then, for the protection of the resistance heating element 133, the resistance heating element 133 was covered with the glass protective layer 134 having a thickness of 60 μm to produce a heater. Then, the surface (surface to be treated) of the glass protective layer 134 on the opposite side to the side opposed to the substrate 132 was degreased with toluene, and was further subjected to surface treatment through corona discharge.

Next, the material D-1 for first phase formation was applied onto the surface to be treated of the glass protective layer 134 by spray coating to cause droplets of the material D-1 for first phase formation to adhere thereto. Specifically, an airbrush (product name: HP-BC1P; manufactured by Anest Iwata Corporation) was connected to a compressor for an airbrush (product name: IS-51; manufactured by Anest Iwata Corporation). Then, spray coating was performed under conditions described below.

Nozzle diameter: 0.3 mm
Ejection pressure: 0.15 MPa
Distance from spray nozzle tip to surface to be treated: 15.0 cm
Relative moving speed of spray nozzle over surface to be treated: 10 mm/s
Needle retreat amount of spray nozzle: 0.25 mm

The heater having the droplets of the material for first phase formation caused to adhere to the surface to be treated was placed in a heating furnace, was heated at a temperature of 100° C. for 10 minutes for the purpose of drying the solvent, and was then heated at a temperature of 120° C. for 15 minutes for the purpose of immobilizing the first phases onto the surface to be treated.

Next, the material M-1 for second phase formation was applied with a brush onto the surface to be treated having the first phases formed thereon to form a layer of the material for second phase formation covering the exposed surface of the surface to be treated, which was not covered with the first phases, and the surfaces of the first phases. Then, the heater having the layer of the material for second phase formation formed thereon was placed in a heating furnace, and was heated at a temperature of 200° C. for 15 minutes to immobilize the second phase to the exposed surface of the surface to be treated. Then, toluene and a fluorine solvent “Novec 7300” (product name, manufactured by 3M Company) were used to remove the unreacted material for second phase formation so that the surfaces of the first phases were exposed.

Thus, a heater having the sliding surface 113S formed of the first phases and the second phase was obtained. The obtained heater was subjected to the following evaluations.

(Evaluation 1: Measurement of Contact Angle and Sliding angle of Sliding Surface)

The heater having the sliding surface formed thereon was placed so that the sliding surface 113S thereof faced vertically upward, and that the sliding surface 113S was horizontal. Then, the contact angle and sliding angle according to the present disclosure were measured under the following conditions. The contact angle and the sliding angle were continuously measured to be evaluated at the same arbitrary position. The kinematic viscosity of a perfluoropolyether used as a hanging drop substance described below was measured by the following method.

A rotary rheometer (product name: DHR2, manufactured by TA Instruments) and a portable density and specific gravity meter (product name: DA-130N, manufactured by Kyoto Electronics Manufacturing Co., Ltd.) were prepared. The portable density and specific gravity meter can measure density by a natural oscillation period measurement system (oscillating type). Then, in the rotary rheometer, with use of a Peltier plate capable of temperature adjustment in the temperature range of from 20° C. to 200° C., and a cone-and-plate geometry having a diameter of 40 mm, the shear rate to be applied to a perfluoropolyether at a temperature of 23° C. was set to 100 s⁻¹, and its absolute viscosity was calculated from the resultant shear stress. Next, in the density meter, the density of the perfluoropolyether having its temperature controlled in a thermostatic chamber at a temperature of 23° C. was measured. A value obtained by dividing the density by the measured absolute viscosity was adopted as the kinematic viscosity.

Apparatus name: Contact Angle Meter “DM-501” (product name, manufactured by Kyowa Interface Science Co., Ltd.)
Hanging drop substance: perfluoropolyether oil (product name: Krytox GPL-105, manufactured by Chemours Company, kinematic viscosity at a temperature of 23° C.: 500 mm²/s)
Hanging drop amount: 1 microliter (droplet diameter: about 1.3 mm)
Measurement waiting time: 1 sec
Tilting speed: 2°/sec
Moving determination distance: 20 μm
Measurement environment: a temperature of 23° C. and a relative humidity of 55%

A measurement value at a time when the sliding surface 113S had a tilt angle of 0°, that is, was horizontal was adopted as the contact angle. In addition, the sliding surface 113S was progressively tilted at the above-mentioned tilting speed, and an angle at which the droplet of the perfluoropolyether started to move on the sliding surface 113S was adopted as the sliding angle.

(Evaluation 2: Measurement of Area Ratio of First Phases and Average Value of Numbers of First Phases in Arbitrary Range on Sliding Surface)

The area ratio of the first phases and the average value of the numbers of the first phases in an arbitrary range on the sliding surface 113S were measured.

That is, the first phases contain fluorine, and hence fluorine element mapping was performed with a scanning electron microscope (SEM) and an energy-dispersive X-ray spectrometer (EDS). Data obtained through the mapping was subjected to binarization and image analysis to determine the area ratio of the first phases and the average value of the numbers of the first phases in an arbitrary range on the sliding surface.

The image processing software ImageJ from the US National Institutes of Health (available from https://imagej.nih.gov/ij/) was used for the binarization and image analysis of a mapping image.

Apparatus name: FE-SEM: “SIGMA 500 VP” (product name, manufactured by Zeiss)
EDS: “X-MaxN80” (product name, manufactured by Oxford Instruments)
   Acceleration voltage: 10 kV
   Working distance: 10 mm
   Magnification: 100 times
   Measurement range: 1,100 μm×820 μm
   Detection element: F component
   Evaluation number: 10 areas/sample
   Binarization and image analysis: ImageJ
   Binarization method: MaxEntropy

After the image acquisition and image analysis performed as described above, the area ratio of the first phases and the average value of the numbers of the first phases in the range of 1.3 mm, i.e., the diameter of the droplet in the measurement of the contact angle and the sliding angle described above, were each determined by calculation from an average value in the area of the measurement range (EDS 10 areas/sample).

The results of the evaluation performed as described above were as follows: the area ratio of the first phases of Example 1 was 57.6%, and the average value of the numbers of the first phases was 973,440.

(Evaluation 3: Recognition of Presence of Second Phase having Alkyl Group, and Measurement of Carbon Number in the Alkyl Group)

The sliding surface 113S was observed using time-of-flight secondary ion mass spectrometry (TOF-SIMS) under the following conditions.

Apparatus name: “PHI TRIFT IV” (product name, manufactured by ULVAC-PHI, Inc.)
Measurement temperature: 23° C.
Irradiation primary ion: Au³⁺ 30 kV
Observation mass number: from 0 to 1,850

Through the above-mentioned measurement, it was recognized that a phase having an alkyl group, that is, the second phase was present in the sliding surface 113S. In addition, the carbon number of the alkyl group in the second phase was identified by comparing the spectrum obtained by the above-mentioned TOF-SIMS to a spectrum obtained by TOF-SIMS using a silane coupling agent having an alkyl group having a known carbon number as a reference sample.

(Evaluation 4: Evaluation as Heat Fixing Device)

The heater having the sliding surface was used to produce the heat fixing device illustrated in FIG. 1A and FIG. 1B. The fixing film 112 was as follows: a polyimide resin was used as a material for the base layer; a carbon-based filler was added in order to improve thermal conductivity and strength; the thickness of the base layer was 60 μm; and the length in the longitudinal direction B and the outer diameter were set to 233 mm and 18 mm, respectively, in an undeformed cylindrical state. A PFA layer having a thickness of 10 μm was arranged as a coat on the surface of the base layer.

As the pressure roller 110, a mandrel made of iron having a length of an elastic layer-formed portion of 220 mm and a diameter of 15 mm was used, and a foamed rubber obtained by foaming a silicone rubber was used to form the elastic layer 116 having a thickness of 2.5 mm. The release layer 118 formed of PFA was formed on the surface of the elastic layer 116 by tube covering. The surface hardness of the pressure roller 110 was 50° in terms of Asker-C hardness.

The fixing film was idly rotated so that the lubricant applied to the sliding surface of the heater 113 blended in the inner peripheral surface of the fixing film 112. Further, a pressurizing force to be applied to the fixing nip N by an urging unit was adjusted to 137.4 N (14 kgf) in terms of total pressure.

In addition, 250 mg of commercially available fluorine grease “MOLYKOTE HP-300” (product name, manufactured by DuPont Toray Specialty Materials K.K.), which contained a perfluoropolyether as a base oil and polytetrafluoroethylene fine particles as a thickener, was applied to the sliding surface of the heater. Thus, there was produced a heat fixing device including a sliding portion in which the inner peripheral surface of the fixing film and the sliding surface of the heater were slidable via an oil film containing a perfluoropolyether. “MOLYKOTE HP-300” contains as a base oil a perfluoropolyether having a kinematic viscosity in the range of from 200 mm²/s to 600 mm²/s at a temperature of 23° C., and contains PTFE particles as a thickener.

The heat fixing device was mounted onto an electrophotographic image forming apparatus (product name: Satera LBP312i, manufactured by Canon Inc.). The electrophotographic image forming apparatus was used to perform an image forming operation (paper passing) of forming an entire surface half tone image whose printing rate is 50%. Specifically, in an office environment (temperature: 23° C., relative humidity: 50%), the temperature of the heater 113 was adjusted to 200° C. with a temperature detecting element (not shown), and every time three sheets of A4 size paper was passed, an interval of 10 seconds followed before the next sheet was passed. Then, the number of sheets passed until a rotation failure of the fixing film due to a reduction in amount of the lubricant in the sliding portion occurred was recorded, and evaluation was performed by the following criteria.

### Evaluation Ranks

Rank A: The number of passable sheets was remarkably increased as compared to the number of sheets passed in Comparative Example 9.

Rank B: The number of passable sheets was increased as compared to the number of sheets passed in Comparative Example 9.

Rank C: The number of sheets passed was reduced as compared to the number of sheets passed in Comparative Example 9.

In addition, at the time point when the number of sheets passed reached 100 thousand, the shaft torque of the pressure roller in the case where the surface speed of the pressure roller was set to 266 mm/sec was measured. The value of the torque used was the average value of the torques during 15 seconds of driving at the time of non-printing. Then, evaluation was performed by the following criteria.

### Evaluation Ranks

Rank A: The torque value is remarkably smaller than the torque value in Comparative Example 9.

Rank B: The torque value is smaller than the torque value in Comparative Example 9.

Rank C: The torque value is larger than the torque value in Comparative Example 9.

### Examples 2 to 8

The material for first phase formation and the material for second phase formation were changed as shown in Table 2. In addition, the spray application conditions for the material for first phase formation were set as shown in Table 3. In addition, the application method for the material for second phase formation was the same as in Example 1 except in Examples 3, 7, and 8. In each of Examples 3, 7, and 8, spray application was performed as with the material for first phase formation. The spray application conditions for the material for second phase formation in Examples 3, 7, and 8 are shown in Table 4. Heaters each having the sliding surface 113S were formed in the same manner as in Example 1 except the foregoing. Then, the resultant heaters were subjected to Evaluation 1 to Evaluation 4 described in Example 1.

TABLE 2

Material for phase formation

| | First phase | Second phase |
|---|---|---|
| Example 1 | D-1 | M-1 |
| Example 2 | D-1 | M-2 |
| Example 3 | D-1 | M-3 |
| Example 4 | D-3 | M-1 |
| Example 5 | D-4 | M-1 |
| Example 6 | D-2 | M-2 |
| Example 7 | D-4 | M-3 |
| Example 8 | D-2 | M-3 |

TABLE 3

| | | Spray application conditions for material for first phase formation | | | | | |
|---|---|---|---|---|---|---|---|
| | | | | Distance from | Relative moving | | |
| | | | | spray nozzle | speed of spray | | |
| | | | | tip to surface | nozzle over | Needle retreat | |
| | | Nozzle | Ejection | to be | surface to be | amount of | Number of |
| | | diameter | pressure | treated | treated | spray nozzle | times of |
| | | (mm) | (MPa) | (cm) | (mm/s) | (mm) | application |
| Example | 1 | 0.3 | 0.15 | 15 | 10 | 0.25 | 100 |
| | 2 | 0.3 | 0.15 | 15 | 10 | 0.50 | 30 |
| | 3 | 0.3 | 0.15 | 15 | 20 | 0.75 | 20 |
| | 4 | 0.3 | 0.15 | 15 | 20 | 1.00 | 20 |
| | 5 | 0.3 | 0.15 | 15 | 30 | 1.25 | 15 |
| | 6 | 0.3 | 0.15 | 15 | 30 | 1.25 | 15 |
| | 7 | 0.3 | 0.15 | 15 | 30 | 1.50 | 10 |
| | 8 | 0.3 | 0.15 | 15 | 30 | 2.00 | 10 |

TABLE 4

| | | Spray application conditions for material for second phase formation | | | | | |
|---|---|---|---|---|---|---|---|
| | | | | | Relative moving | | |
| | | | | Distance from | speed of spray | Needle | |
| | | | | spray nozzle | nozzle over | retreat | |
| | | Nozzle | Ejection | tip to surface | surface to be | amount of | Number of |
| | | diameter | pressure | to be treated | treated | spray nozzle | times of |
| | | (mm) | (MPa) | (cm) | (mm/s) | (mm) | application |
| Example | 3 | 0.3 | 0.15 | 15 | 10 | 3 | 20 |
| | 7 | 0.3 | 0.15 | 15 | 10 | 3 | 20 |
| | 8 | 0.3 | 0.15 | 15 | 10 | 3 | 20 |

### Comparative Example 1

In Example 1, the number of times of the spray application of the material for first phase formation was increased to 5, and the application of the material for second phase formation was not performed. A heater was produced in the same manner as in Example 1 except the foregoing. That is, the sliding surface of the heater according to Comparative Example 1 was formed only of the first phase. This heater was subjected to Evaluations 1 to 3 described in Example 1. In addition, a heat fixing device was produced in the same manner as in Example 1 except for using this heater, and the resultant heat fixing device was subjected to Evaluation 4 described in Example 1.

### Comparative Example 2

In Example 1, the application of the material for first phase formation was not performed. A heater was produced in the same manner as in Example 1 except the foregoing. That is, the sliding surface of the heater according to Comparative Example 2 was formed only of the second phase. This heater was subjected to Evaluation 1 to Evaluation 3 described in Example 1. In addition, a heat fixing device was produced in the same manner as in Example 1 except for using this heater, and the resultant heat fixing device was subjected to Evaluation 4 described in Example 1.

### Comparative Examples 3 to 8

The material for first phase formation and the material for second phase formation were changed as shown in Table 5. In addition, the spray application conditions for the material for first phase formation were set as shown in Table 6. In addition, the application method for the material for second phase formation was the same as in Example 1 except in Comparative Example 6. In Comparative Example 6, spray application was performed as with the material for first phase formation. The conditions for the spray application of the material for second phase formation in Comparative Example 6 are shown in Table 7. Heaters were produced in the same manner as in Example 1 except the foregoing. The resultant heaters were subjected to Evaluation 1 to Evaluation 3 described in Example 1. In addition, heat fixing devices were produced in the same manner as in Example 1 except for using the heaters according to respective Comparative Examples, and were subjected to Evaluation 4 described in Example 1.

TABLE 5

Material for phase formation

| | First phase | Second phase |
|---|---|---|
| Comparative Example 3 | D-1 | M-1 |
| Comparative Example 4 | D-1 | M-1 |
| Comparative Example 5 | D-2 | M-2 |
| Comparative Example 6 | D-2 | M-3 |
| Comparative Example 7 | D-4 | M-1 |
| Comparative Example 8 | D-3 | M-1 |

TABLE 6

| | | Spray application conditions for material for first phase formation | | | | | |
|---|---|---|---|---|---|---|---|
| | | | | | Relative | | |
| | | | | | moving speed | Needle | |
| | | | | Distance from | of spray | retreat | |
| | | | | spray nozzle tip | nozzle over | amount of | |
| | | Nozzle | Ejection | to surface to be | surface to be | spray | Number of |
| | | diameter | pressure | treated | treated | nozzle | times of |
| | | (mm) | (MPa) | (cm) | (mm/s) | (mm) | application |
| Comparative | 3 | 0.3 | 0.15 | 15 | 40 | 3.00 | 5 |
| Example | 4 | 0.3 | 0.15 | 15 | 30 | 1.00 | 5 |
| | 5 | 0.3 | 0.15 | 15 | 40 | 2.75 | 5 |
| | 6 | 0.3 | 0.15 | 15 | 20 | 5.00 | 1 |
| | 7 | 0.3 | 0.15 | 15 | 20 | 2.50 | 2 |
| | 8 | 0.3 | 0.15 | 15 | 30 | 1.00 | 10 |

TABLE 7

| | | Spray application conditions for material for second phase formation | | | | | |
|---|---|---|---|---|---|---|---|
| | | | | | Relative | | |
| | | | | | moving | Needle | |
| | | | | Distance from | speed of | retreat | |
| | | | | spray nozzle tip | spray nozzle | amount of | |
| | | Nozzle | Ejection | to surface to be | over surface | spray | Number of |
| | | diameter | pressure | treated | to be treated | nozzle | times of |
| | | (mm) | (MPa) | (cm) | (mm/s) | (mm) | application |
| Comparative | 6 | 0.3 | 0.15 | 15 | 10 | 3 | 20 |
| Example | | | | | | | |

### Comparative Example 9

A heater was produced in the same manner as in Example 1 except that the first phase and the second phase were not formed. That is, the sliding surface of the heater according to this Comparative Example was formed of glass. This heater was subjected to Evaluation 1 to Evaluation 3 described in Example 1. In addition, a heat fixing device was produced in the same manner as in Example 1 except for using this heater, and was subjected to Evaluation 4 described in Example 1.

The results of Evaluation 1 to Evaluation 4 for Examples 1 to 8 and Comparative Examples 1 to 9 are shown in Table 8.

TABLE 8

| | | | | | | Carbon | | | | |
|---|---|---|---|---|---|---|---|---|---|---|
| | | | | | Average | number of | Torque after 100 | | | |
| | | | | Area | value of | alkyl group | thousand-sheet | | Number of sheets | |
| | | Contact | Sliding | ratio of | numbers of | in matrix | printing | | passed | |
| | | angle | angle | domains | domains | [carbon | | Evaluation | [thousand | Evaluation |
| | | [°] | [°] | [%] | [domains] | atom(s)] | [N · cm] | rank | sheets] | rank |
| Example | 1 | 64.2 | 39.3 | 57.6 | 973,440 | 1 | 38.2 | A | 290 | A |
| | 2 | 57.8 | 37.6 | 47.2 | 65,117 | 1 | 36.3 | A | 270 | A |
| | 3 | 62.3 | 32.7 | 32.4 | 9,000 | 6 | 39.2 | A | 230 | A |
| | 4 | 58.2 | 39.5 | 42.3 | 7,921 | 1 | 37.2 | A | 240 | A |
| | 5 | 54.7 | 38.1 | 53.9 | 7,262 | 1 | 37.2 | A | 300 | A |
| | 6 | 52.1 | 37.2 | 58.6 | 6,140 | 1 | 43.1 | A | 220 | A |
| | 7 | 50.5 | 31.8 | 47.8 | 3,277 | 6 | 53.9 | B | 230 | A |
| | 8 | 51.8 | 30.2 | 58.7 | 2,609 | 6 | 47.0 | A | 210 | B |
| Comparative | 1 | 45.2 | 37.0 | 100.0 | — | — | 58.8 | C | 140 | C |
| Example | 2 | 59.6 | 17.7 | 0.0 | — | 1 | 70.6 | C | 150 | C |
| | 3 | 46.7 | 27.5 | 45.7 | 750 | 1 | 56.8 | C | 160 | C |
| | 4 | 53.5 | 22.3 | 14.8 | 1,796 | 1 | 60.8 | C | 175 | C |
| | 5 | 46.2 | 31.2 | 65.0 | 1,334 | 1 | 57.8 | C | 170 | C |
| | 6 | 46.7 | 31.0 | 54.0 | 126 | 6 | 65.7 | C | 135 | C |
| | 7 | 51.2 | 23.0 | 26.0 | 703 | 1 | 63.7 | C | 155 | C |
| | 8 | 51.3 | 21.7 | 19.8 | 4,857 | 1 | 59.8 | C | 160 | C |
| | 9 | 45.8 | 33.5 | — | — | — | 55.9 | — | 200 | — |

For each of the heat fixing devices of Examples 1 to 8, the sliding surface 113S was controlled to have a contact angle of 50° to 65°, and a sliding angle in the range of 30° to 40°. As a result, in each case, the evaluation rank of the torque after 100 thousand-sheet printing and the number of passable sheets were “A” or “B”, indicating that low slidability and durability superior to those of a related-art example were exhibited.

Of those, in Example 1, in which, when it was assumed that a true circle having a diameter of 1.3 mm was placed at an arbitrary position on the sliding surface, the average value of the numbers of the first phases contained in the true circle was a large number, the number of sheets passed was 290 thousand sheets, which was 1.45 times the number of sheets passed of Comparative Example 9. In addition, the torque of the heat fixing device according to Example 1 after 100 thousand-sheet printing was 0.68 times the torque of the heat fixing device according to Comparative Example 9 after 100 thousand-sheet printing. Those evaluation results are conceivably due to the following: in the heat fixing device according to Example 1, an oil film formed of the fluorine grease was stably formed on the sliding surface, and besides, its leakage from the sliding surface was able to be prevented.

The entirety of the sliding surface of the heater according to Comparative Example 1 was formed of the first phases forming at least part of the sliding surface of the heater according to Example 1. Accordingly, the sliding surface of the heater according to Comparative Example 1 blended well with the perfluoropolyether, and hence the sliding angle showed a value as high as 37.0°. Meanwhile, the perfluoropolyether was liable to wet and spread on the sliding surface, and hence the contact angle showed a value as low as 45.2°. Besides, it is conceived that, in the heat fixing device including the heater according to Comparative Example 1, the fluorine grease excessively wetted and spread on the sliding surface of the heater, and an oil film having a sufficient thickness was not formed in the sliding portion. As a result, it is conceived that the oil film in the sliding portion was depleted through long-term printing, and hence, as shown in the results of Evaluation 4, the torque after 100 thousand-sheet printing was increased and the number of sheets passed was reduced.

The entirety of the sliding surface of the heater according to Comparative Example 2 was formed of the second phase forming at least part of the heater according to Example 1. Accordingly, the sliding surface of the heater according to Comparative Example 2 repelled the perfluoropolyether well, and hence the contact angle showed a value as high as 59.6°. Meanwhile, the droplet of the perfluoropolyether was liable to flow on the sliding surface, and hence the sliding angle showed such an excessively low value as 17.7°. Besides, it is conceived that, in the heat fixing device including the heater according to Comparative Example 2, the perfluoropolyether-holding force of the sliding surface of the heater was weak. As a result, it is conceived that, in the heat fixing device according to Comparative Example 2, the fluorine grease leaked from the sliding portion through long-term printing, and hence, as shown in the results of Evaluation 4, the torque after 100 thousand-sheet printing was increased and the number of sheets passed was reduced.

The sliding surfaces of the heaters according to Comparative Examples 5 and 6 each had a contact angle of less than 50°. Accordingly, it is conceived that, in each of the heat fixing devices including those heaters, the fluorine grease excessively wetted and spread on the sliding surface of the heater, and an oil film having a sufficient thickness was not formed in the sliding portion. As a result, it is conceived that, in each of the heat fixing devices according to Comparative Examples 5 and 6, the oil film in the sliding portion was depleted through long-term printing, and hence, as shown in the results of Evaluation 4, the torque after 100 thousand-sheet printing was increased and the number of sheets passed was reduced.

In addition, the sliding surfaces of the heaters according to Comparative Examples 4, 7, and 8 each had a sliding angle of less than 30°. It is conceived that, in each of the heat fixing devices including those heaters, the perfluoropolyether-holding force of the sliding surface of the heater was weak. As a result, it is conceived that, in each of the heat fixing devices according to Comparative Examples 4, 7, and 8, the fluorine grease leaked from the sliding portion through long-term printing, and hence, as shown in the results of Evaluation 4, the torque after 100 thousand-sheet printing was increased and the number of sheets passed was reduced.

Further, the sliding surface of the heater according to Comparative Example 3 had a contact angle of less than 50°, and also had a sliding angle of less than 30°. It is conceived that, in the heat fixing device including this heater, the fluorine grease excessively wetted and spread on the sliding surface of the heater, and an oil film having a sufficient thickness was not formed in the sliding portion, and besides the perfluoropolyether-holding force of the sliding surface was weak. As a result, it is conceived that, in the heat fixing device according to Comparative Example 3, the oil film in the sliding portion was depleted and leaked through long-term printing, and hence, as shown in the results of Evaluation 4, the torque after 100 thousand-sheet printing was increased and the number of sheets passed was reduced.

The sliding surface of the heater according to Comparative Example 9 was formed of glass. The contact angle of the sliding surface was less than 50°. Accordingly, it is conceived that, in the heat fixing device including the heater according to Comparative Example 9, as in Comparative Example 1, the fluorine grease excessively wetted and spread on the sliding surface of the heater, and an oil film having a sufficient thickness was not formed in the sliding portion. As a result, it is conceived that the oil film in the sliding portion was depleted through long-term printing, and hence, as shown in the results of Evaluation 4, the torque after 100 thousand-sheet printing was increased and the number of sheets passed was reduced.

As demonstrated by the above-mentioned results, it is understood that a sliding device and a heat fixing device each capable of stably maintaining satisfactory slidability at the sliding portion can be obtained by virtue of the slidable member having the sliding surface achieving both of the contact angle and sliding angle according to the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-045820, filed Mar. 22, 2022, and Japanese Patent Application No. 2023-033821, filed Mar. 6, 2023, which are hereby incorporated by reference herein in their entirety.

What is claimed is:

1. A heat fixing device comprising:
a first member configured to be rotatable;
a heater capable of heating the first member;
a second member configured to be rotatable, which forms a nip portion with the first member, at the nip portion a recording material being held with the first member; and
a biasing member, which is arranged inside the first member, has a sliding surface against an inner peripheral surface of the first member, and is configured to bias the first member toward the second member,
the heat fixing device having an oil film containing a perfluoropolyether, the oil film being present between the inner peripheral surface of the first member and the sliding surface of the biasing member, and
when adhering a 1-microliter droplet of a perfluoropolyether having a kinematic viscosity of 500 mm²/s at an arbitrary position on the sliding surface at a temperature of 23° C., a contact angle of the droplet being 50° to 65°, and a sliding angle of the droplet being 30° to 40°.

2. The heat fixing device according to claim 1, wherein the contact angle is 52° to 65°.

3. The heat fixing device according to claim 1, wherein the sliding angle is 32° to 40°.

4. The heat fixing device according to claim 1, wherein the sliding surface includes at least:
a first phase containing a fluorine atom; and
a second phase containing an alkyl group having 1 to 10 carbon atoms.

5. The heat fixing device according to claim 4, wherein, when placing a true circle having a diameter of 1.3 mm at an arbitrary position on the sliding surface, a sum of areas of the first phases contained in the true circle is 30% to 60% with respect to an area of the true circle. and

6. The heat fixing device according to claim 5,
wherein the first phases are dispersed as domains in a matrix of the second phase, and
wherein an average value of numbers of the first phases present in the true circle is 2,500 to 1,000,000.

7. The heat fixing device according to claim 5,
wherein the first phases are dispersed as domains in a matrix of the second phase, and
wherein an average value of numbers of the first phases present in the true circle is 5,000 to 1,000,000.

8. A sliding device comprising a first member and a second member, which are brought into contact with each other in a relatively slidable manner with an oil film in-between,
the oil film containing a perfluoropolyether,
the first member having a first surface opposed to the second member,
the second member having a second surface opposed to the first member, and
at least one surface selected from the group consisting of: the first surface and the second surface, satisfies the following conditions:
<Conditions>
When adhering a 1-microliter droplet of a perfluoropolyether having a kinematic viscosity of 500 mm²/s at an arbitrary position on the at least one surface at a temperature of 23° C., a contact angle of the droplet is 50° to 65°, and a sliding angle of the droplet is 30° to 40°.

9. The sliding device according to claim 8, wherein the contact angle is 52° to 65°, and the sliding angle is 32° to 40°.

10. The sliding device according to claim 8, wherein the at least one surface satisfying the conditions includes:
a first phase containing a fluorine atom; and
a second phase containing an alkyl group having 1 to 10 carbon atoms.

11. The sliding device according to claim 10, wherein, when placing a true circle having a diameter of 1.3 mm at an arbitrary position on the at least one surface satisfying the conditions, a sum of areas of the first phases contained in the true circle is 30% to 60% with respect to an area of the true circle.

12. The sliding device according to claim 11, wherein an average value of numbers of the first phases present in the true circle is 2,500 to 1,000,000.

13. A slidable member configured to relatively slide with respect to another member with an oil film that contains a perfluoropolyether in-between,
the slidable member having a first surface with which the oil film is brought into contact, and
a contact angle of a 1-microliter droplet of a perfluoropolyether having a kinematic viscosity of 500 mm²/s with respect to the first surface at a temperature of 23° C. being 50° to 65°, and
a sliding angle of the droplet with respect to the first surface at a temperature of 23° C. being 30° to 40°.

14. The slidable member according to claim 13, wherein the contact angle is 52° to 65°, and the sliding angle is 32° to 40°.

15. The slidable member according to claim 13, wherein the first surface includes:
a first phase containing a fluorine atom; and
a second phase containing an alkyl group having 1 to 10 carbon atoms.

16. The slidable member according to claim 15,
wherein the first phases are dispersed as domains in a matrix of the second phase, and
when placing a true circle having a diameter of 1.3 mm at an arbitrary position on the sliding surface, a sum of areas of the first phases contained in the true circle is 30% to 60% with respect to an area of the true circle.

17. The slidable member according to claim 16, wherein an average value of numbers of the first phases present in the true circle is 2,500 to 1,000,000.
